(19) United States
(12) Patent Application Publication
(10) Pub. No.: US 2015/0359371 A1
(43) Pub. Date: Dec. 17, 2015

(54) MAIL NOTIFICATION DEVICE

(71) Applicant: Jim Giovinco, Sellersville, PA (US)

(72) Inventor: Jim Giovinco, Sellersville, PA (US)

(21) Appl. No.: 14/303,816

(22) Filed: Jun. 13, 2014

(51) Int. Cl. A47G 29/122; H04W 4/12; H04W 4/00

(52) U.S. Cl. CPC A47G 29/1225; H04W 4/005; H04W 4/12; A47G 2029/1226

(57) ABSTRACT

A mail notification device to alert when mail is received comprising a housing, where the housing includes a top and a base; an attachment means below the base, where the attachment means secures the housing within a mailbox; a sensor within the top of the housing, where the sensor sends an alert when mail is detected within the mailbox; and a handheld wireless communication device, where the handheld wireless communication device receives the alert thereby informing a user that mail is present within the mailbox.

### BACKGROUND OF THE INVENTION

1. Field of the Invention

The present invention relates to a sensor that informs a user that mail has arrived in a mailbox.

2. Description of Related Art

Anyone who owns a home or has a place of business still receives physical mail. While email is an immediate form of correspondence, most important papers are still delivered physically. Often people ignore many of their emails, due to the mass quantity they receive on a daily basis. This may cause an important message or correspondence to be missed or forgotten. For this reason, most secure mail like bank statements, credit cards, and utility bills are received in the mail.

For many, checking the mailbox can be frustrating and time consuming especially when the mailbox is not directly outside the home or office. The person must walk or drive to the mailbox, and then are met with disappointment if the mail has yet to be delivered. This is even more tedious if the person checks the mail multiple times in a day in anticipation of an important letter, package or check. They must either learn the timeliness of their mail carrier, continuously watch the mailbox, or repeatedly check until their letter is received.

Therefore it would be beneficial in the art to provide a device that informs a user that their mail is in the box. It would also be desirable in the art to provide a mail notification device that alerts the user as to the delivery even when they are not home.

### SUMMARY OF THE INVENTION

In view of the foregoing disadvantages inherent in the prior art, the general purpose of the present invention is to provide a mail notification device to alert when mail is received, configured to include all of the advantages of the prior art, and to overcome the drawbacks inherent therein.

Accordingly, an object of the present invention is to provide a mail notification device that alerts a user when mail is received. The device includes a sensor mounted within a mailbox that sends an alert when mail enters the box.

Another object of the present invention is to provide a mail notification device that sends a text message or email to a user to alert them that their mail has arrived.

To achieve the above objects, in an aspect of the present invention, a mail notification device is described comprising a housing, where the housing includes a top and a base; an attachment means below the base, where the attachment means secures the housing within a mailbox; a sensor within the top of the housing, where the sensor sends an alert when mail is detected within the mailbox; and a handheld wireless communication device, where the handheld wireless communication device receives the alert thereby informing a user that mail is present within the mailbox.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a mail notification device in accordance with an exemplary embodiment of the present invention; and

FIG. 2 depicts a top view of a mail notification device in accordance with an exemplary embodiment of the present invention.

Like reference numerals refer to like parts throughout the description of several views of the drawings.

### DETAILED DESCRIPTION OF THE DRAWINGS

The present invention relates to a device that informs a user that mail has arrived in a mailbox. The present invention provides a mail notification device to alert a user that the mail was delivered. The mail notification device is mounted within a mailbox. Once the mailbox is opened, a notification message is automatically sent to the user thereby informing them that the mail was placed into the box. More routinely medications are being ordered by mail. The mail notification device 10 ensures that the medications are gathered in a timely manner to maintain proper dosage and before theft or extreme temperature exposure. With the mail notification device the user is alerted immediately that the mail arrived so that they don't miss important packages or letters.

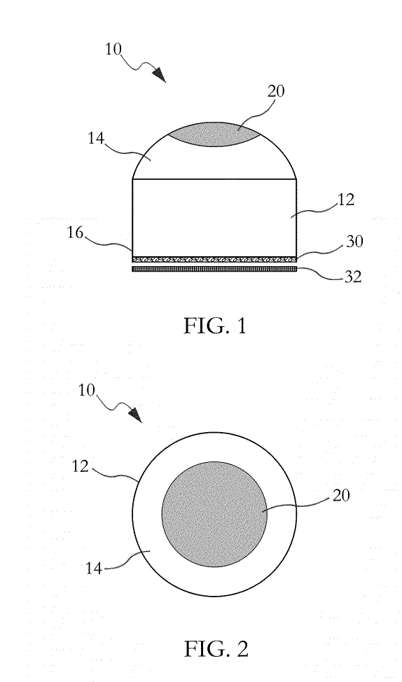

Turning now descriptively to the drawings, referring to FIG. 1, a mail notification device 10 is shown in accordance with an exemplary embodiment of the present invention. The mail notification device 10 includes a housing 12 that is attached within a mailbox. The housing 12 includes a top 14 and a base 16. The housing 12 may comprise a generally cylindrical shape, where the base 16 is flat and the top 14 is rounded like a dome. The housing 12 may include a port 18 to connect a computing device. The port 18 may receive a USB cord or other connection cord that enables connection between the housing 12 and a computer, smartphone, computing tablet or the like.

Within top 14 of the housing 12 is a sensor 20. The sensor 20 detects when mail is placed within the mailbox. The sensor 20 may be a motion, light or proximity sensor. With the motion sensor the mail notification device 10 alerts the user when the mail is inserted into the box. With the light sensor the mail notification device 10 may send an alert when the mailbox is opened and light enters. Finally, with the proximity sensor the mail notification device 10 may send an alert when the mail is actually positioned within the mailbox. With the proximity sensor, false alarms may be avoided by only sending an alert when the mail is near the sensor 20 instead of when the light enters or door opens.

The sensor 20 may include a timer and a lithium battery. The timer may be set to predetermined hour parameters, where if the mailbox is opened within that time period an alert is sent to indicate the user as to potential theft. The sensor 20 may be coupled with a wireless communication system where once mail is received the wireless communication system sends an alert to a smartphone, computer or other handheld, wireless communication device. The alert sent from the sensor 20 may be a text, email, or message sent directly into an app to immediately inform the user as to the receipt of mail. The app on the computing device or wireless communication device may enable operation of the mail notification device 10 allowing the user to set time parameters, view times that the alerts were sent, how the user will be alerted (i.e., text, email, ring) and other similar functions. The housing 12 may connect wirelessly via Bluetooth® or may connect via the port 18 and a connection cord.

On the base 16 of the housing 12 is an attachment means 30, 32. The attachment means 30, 32 secures the mailbox notification device 10 within the mailbox. The attachment means 30, 32 may be a hook and loop fastener, an adhesive tab, a suction cup or the like. A first portion 30 may be coupled to the base 16 of the housing 12 while a second portion 32 is affixed within the mailbox. This way the device 10 is removable from within the mailbox. The attachment means 30, 32 enables the mail notification device 10 to fasten within any type of mailbox including a standard freestanding mailbox, a wall secured mailbox, one or more units within a cluster mailbox or the like. This way the user is automatically alerted regardless of the distance from the user and the mailbox.

Referring now to FIG. 2, a top view of the mail notification device 10 is shown. The sensor 20 may be positioned centrally within the top 14 of the housing 12. By also being domed shaped, the sensor 20 is able to efficiently detect movement, light and proximity. The mail notification device 10 may be plastic with a waterproof housing 12 to ensure function in all weather conditions. In commerce, the mail notification device 10 may be known as MAIL'S HERE. With the mail notification device 10 the user is ensured to always pick up their mail in a timely manner and not waste time unnecessarily checking.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A mail notification device to alert when mail is received comprising:
a. a housing, where the housing includes a top and a base;
b. an attachment means below the base, where the attachment means secures the housing within a mailbox;
c. a sensor within the top of the housing, where the sensor sends an alert when mail is detected within the mailbox; and
d. a handheld wireless communication device, where the handheld wireless communication device receives the alert thereby informing a user that mail is present within the mailbox.

2. The mail notification device according to claim 1, where the housing is generally cylindrical and the top is domed.

3. The mail notification device according to claim 1, where the attachment means enables the housing to be removable within the mailbox.

4. The mail notification device according to claim 3, where the attachment means is a hook and loop fastener, where a first portion is attached to the base and a second portion is attached within the mailbox.

5. The mail notification device according to claim 3, where the attachment means is a suction cup.

6. The mail notification device according to claim 1, where the sensor is one of at least a motion, light or proximity sensor.

7. The mail notification device according to claim 1, where the housing includes a port, where the port enables connection to a computing device.

8. The mail notification device according to claim 1, where the sensor is coupled to a wireless communication system, where the wireless communication system receives the alert from the sensor to then alert the user on the handheld, wireless communication device.

9. The mail notification device according to claim 8, where the alert is received as a text message.

10. The mail notification device according to claim 8, where the alert is received as an email.
